(19) United States
(12) Patent Application Publication
(10) Pub. No.: US 2020/0068133 A1
(43) Pub. Date: Feb. 27, 2020

(54) Edge-Facing Camera Enabled Systems, Methods and Apparatuses

(71) Applicant: Magical Technologies, LLC, Redmond, WA (US)

(72) Inventor: Nova Spivack, REDMOND, WA (US)

(21) Appl. No.: 16/547,817

(22) Filed: Aug. 22, 2019

Related U.S. Application Data
(60) Provisional application No. 62/723,391, filed on Aug. 27, 2018.

(51) Int. Cl. H04N 5/232; H04N 5/225; H04N 5/247; H04M 1/02; H04M 1/215

(52) U.S. Cl. CPC H04N 5/23299; H04N 5/23216; H04N 5/2253; H04M 2250/20; H04N 5/2257; H04M 1/0264; H04M 1/215; H04N 5/247

(57) ABSTRACT

Edge-facing camera enabled systems, methods and apparatuses are disclosed. In one aspect, embodiments of the present disclosure include a method, which may be implemented on a system, to increase adjust an orientation of an imaging unit of a mobile phone. The method can further include tilting a direction of the imaging unit of the mobile phone to adjust the orientation, where, the direction of the imaging unit of the mobile phone is tilted in towards a front side, a back side or an edge side of the mobile phone

### CLAIM OF PRIORITY

This application claims the benefit of:
U.S. Provisional Application No. 62/723,391, filed Aug. 27, 2018 and entitled “Edge Oriented Camera System,” (8012.US00), the contents of which are incorporated by reference in their entirety.

### TECHNICAL FIELD

The disclosed technology relates generally to systems, methods and apparatuses of an edge oriented camera system.

### BACKGROUND

The advent of the World Wide Web and its proliferation in the 90's transformed the way humans conduct business, personal lives, consume/communicate information and interact with or relate to others. A new wave of technology is on the cusp of the horizon to revolutionize our already digitally immersed lives.

### BRIEF DESCRIPTION OF THE DRAWINGS

FIG. 1 illustrates an example block diagram of a host server able to facilitate adjustment of an orientation of an imaging unit of a mobile device or user device, in accordance with embodiments of the present disclosure.

FIG. 2A depicts an example of a user interface of an edge view, a back view and a front view of a mobile device with an edge-facing camera, in accordance with embodiments of the present disclosure.

FIG. 2B depicts an example of a user interface of an edge view, a back view and a front view of a mobile device with an edge-facing camera, in accordance with embodiments of the present disclosure.

FIG. 2C depicts an example diagram showing an edge-facing camera in operation, in accordance with embodiments of the present disclosure.

FIG. 3A depicts an example functional block diagram of a host server that facilitates adjustment of an orientation of an imaging unit of a mobile device or user device, in accordance with embodiments of the present disclosure.

FIG. 3B depicts an example block diagram illustrating the components of the host server that facilitates adjustment of an orientation of an imaging unit of a mobile device or user device, in accordance with embodiments of the present disclosure

FIG. 4A depicts an example functional block diagram of a client device such as a mobile device having an imaging unit with edge-facing capabilities, in accordance with embodiments of the present disclosure.

FIG. 4B depicts an example block diagram of the client device, which can be a mobile device having an imaging unit with edge-facing capabilities, in accordance with embodiments of the present disclosure.

FIG. 5 depicts a flow chart illustrating an example process to adjust an orientation of an imaging unit of a mobile phone, in accordance with embodiments of the present disclosure

FIG. 6 is a block diagram illustrating an example of a software architecture that may be installed on a machine, in accordance with embodiments of the present disclosure.

FIG. 7 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for adjusting levels of perceptibility of user-perceivable content/information via a platform which facilitates user interaction with objects in a digital environment. Aspects of the present disclosure include techniques to control or adjust various mixtures of perceptibility, in a digital environment, between the real world objects/content/environment and virtual objects/content/environment. Embodiments of the present disclosure further include control or adjustment of relative perceptibility between real things (e.g., real world objects/content/environment) and virtual things (e.g., virtual objects/content/environment).

The innovation includes for example, techniques to control or adjust various mixtures of perceptibility, in a digital environment, between the real world objects/content/environment and virtual objects/content/environment.

Digital Objects

The digital objects presented by the disclosed system in a digital environment, can, for instance, include:

a) ‘virtual objects’ which can include any computer generated, computer animated, digitally rendered/reproduced, artificial objects/environment and/or synthetic objects/environment. Virtual objects need not have any relation or context to the real world or its phenomena or its object places or things. Virtual objects generally also include the relative virtual objects or ‘simulated objects’ as described below in b).

b) ‘Relative virtual objects’ or also referred to as ‘simulated objects’ can generally include virtual objects/environments that augment or represent real objects/environments of the real world. Relative virtual objects (e.g., simulated objects) generally further include virtual objects that are temporally or spatially relevant and/or has any relation, relevance, ties, correlation, anti-correlation, context to real world phenomenon, concepts or its objects, places, persons or things; ‘relative virtual objects’ or ‘simulated objects’ can also include or have relationships to, events, circumstances, causes, conditions, context, user behavior or profile or intent, nearby things, other virtual objects, program state, interactions with people or virtual things or physical things or real or virtual environments, real or virtual physical laws, game mechanics, rules. In general ‘relative virtual objects’ can include any digital object that appears, disappears, or is generated, modified or edited based on any of the above factors.

c) ‘Reality objects’ or ‘basic reality objects’ which can perceptibly (e.g., visually or audibly) correspond to renderings or exact/substantially exact reproductions of reality itself. Reality includes tangibles or intangible in the real world. Such renderings or reproductions can include by way of example, an image, a (screenshot) shot, photo, video, live stream of a physical scene and/or its visible component or recordings or (live) stream of an audible component, e.g., sound of an airplane, traffic noise, Niagara falls, birds chirping.

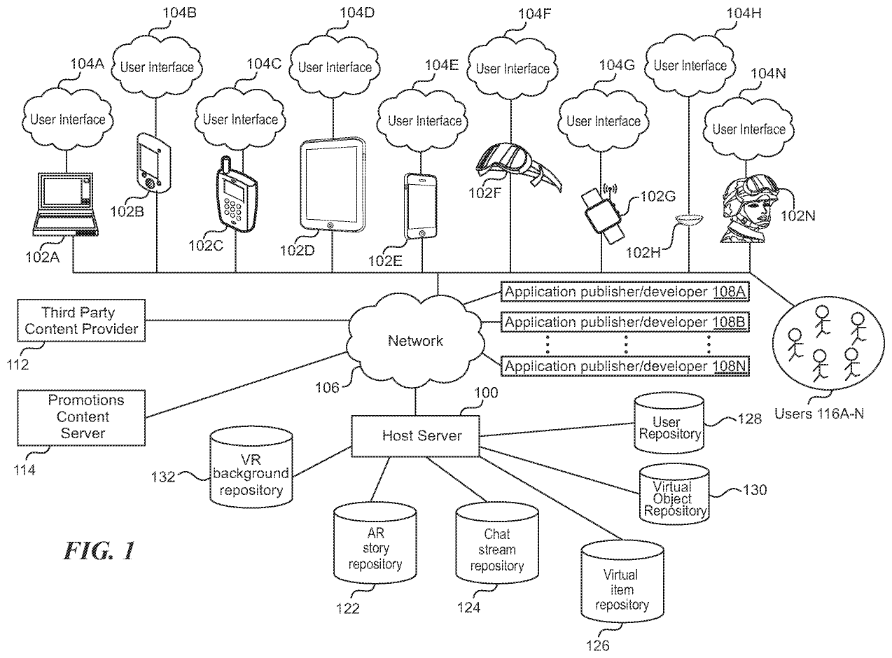

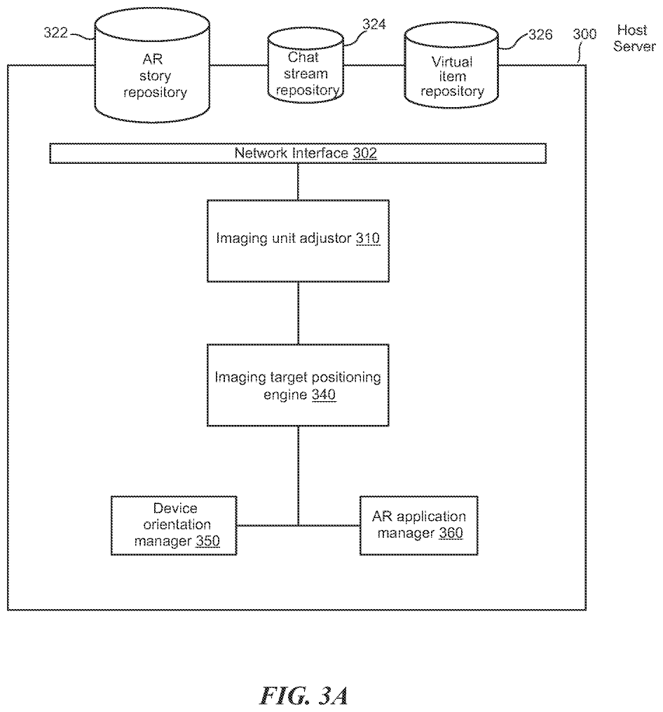

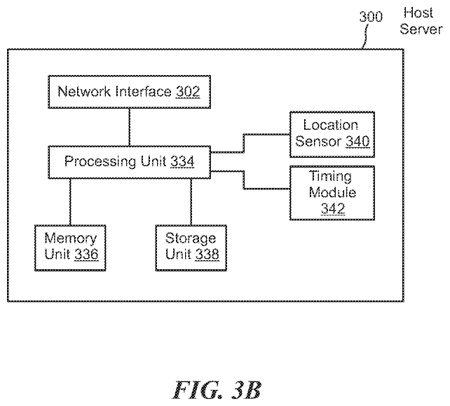

The disclosed system (e.g. host server 100 of FIG. 1 and/or host server 300 of FIG. 3A-3B) can depict/present/augment, via a user device any combination/mixture of: virtual objects (including ‘relative virtual objects’) and reality objects (or, also referred to as ‘basic reality objects’). Any mixture of such objects can be depicted in a digital environment (e.g., via visible area or user-perceptible area on a display or device, or a projection in the air/space).

Embodiments of the present disclosure further enable and facilitate adjustment and selection of the level/degree of perceptibility amongst the objects of varying levels of ‘virtualness.’ by a user, by a system, a platform or by any given application/software component in a given system.

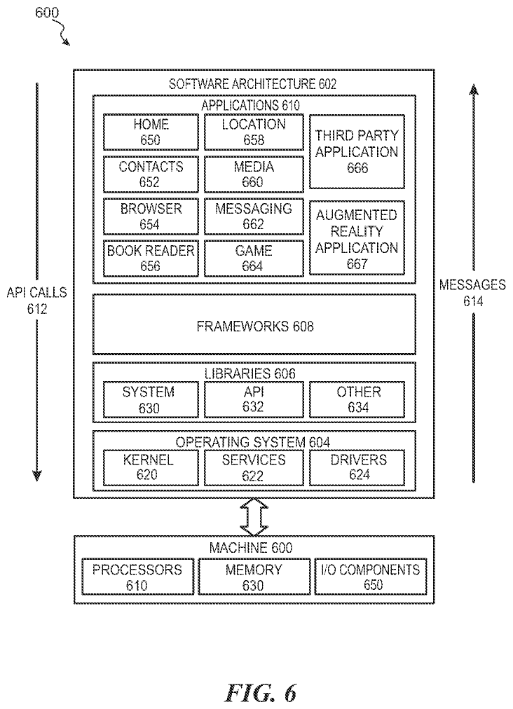

Specifically, innovative aspects of the present disclosure include facilitating selection or adjustment of perceptibility (human perceptibility) amongst the virtual objects, reality objects, and/or relative virtual objects (e.g., simulated objects) in a digital environment (e.g., for any given scene or view). This adjustment and selection mechanism (e.g., via the user controls shown in the examples of FIG. 6A-6B) affects the virtualness of any given digital environment, with increased perceptibility of virtual objects generally corresponding to a higher virtualness level, with decreased perceptibility of virtual objects corresponding to a lower virtualness level. Similarly, decreased perceptibility of reality objects corresponds to increased virtualness and increased perceptibility of reality objects corresponds generally to decreased virtualness.

In one example embodiment of the present disclosure, opacity is used to adjust various components or objects in a digital environment can be thought of or implemented as a new dimension in a platform or user interface like window size and window location.

Embodiments of the present disclosure include systems, methods and apparatuses of platforms (e.g., as hosted by the host server 100 as depicted in the example of FIG. 1) for deployment and targeting of context-aware virtual objects and/or behavior modeling of virtual objects based on physical laws or principle. Further embodiments relate to how interactive virtual objects that correspond to content or physical objects in the physical world are detected and/or generated, and how users can then interact with those virtual objects, and/or the behavioral characteristics of the virtual objects, and how they can be modeled. Embodiments of the present disclosure further include processes that augmented reality data (such as a label or name or other data) with media content, media content segments (digital, analog, or physical) or physical objects. Yet further embodiments of the present disclosure include a platform (e.g., as hosted by the host server 100 as depicted in the example of FIG. 1) to provide an augmented reality (AR) workspace in a physical space, where a virtual object can be rendered as a user interface element of the AR workspace.

Embodiments of the present disclosure further include systems, methods and apparatuses of platforms (e.g., as hosted by the host server 100 as depicted in the example of FIG. 1) for managing and facilitating transactions or other activities associated with virtual real-estate (e.g., or digital real-estate). In general, the virtual or digital real-estate is associated with physical locations in the real world. The platform facilitates monetization and trading of a portion or portions of virtual spaces or virtual layers (e.g., virtual real-estate) of an augmented reality (AR) environment (e.g., alternate reality environment, mixed reality (MR) environment) or virtual reality VR environment.

In an augmented reality environment (AR environment), scenes or images of the physical world is depicted with a virtual world that appears to a human user, as being superimposed or overlaid of the physical world. Augmented reality enabled technology and devices can therefore facilitate and enable various types of activities with respect to and within virtual locations in the virtual world. Due to the inter connectivity and relationships between the physical world and the virtual world in the augmented reality environment, activities in the virtual world can drive traffic to the corresponding locations in the physical world. Similarly, content or virtual objects (VOBs) associated with busier physical locations or placed at certain locations (e.g., eye level versus other levels) will likely have a larger potential audience.

By virtual of the inter-relationship and connections between virtual spaces and real world locations enabled by or driven by AR, just as there is a value to real-estate in the real world locations, there can be inherent value or values for the corresponding virtual real-estate in the virtual spaces. For example, an entity who is a right holder (e.g., owner, renter, sub-lettor, licensor) or is otherwise associated a region of virtual real-estate can control what virtual objects can be placed into that virtual real-estate.

The entity that is the rightholder of the virtual real-state can control the content or objects virtual objects) that can be placed in it, by whom, for how long, etc. As such, the disclosed technology includes a marketplace (e.g., as run by server 100 of FIG. 1) to facilitate exchange of virtual real-estate (VRE) such that entities can control object or content placement to a virtual space that is associated with a physical space.

Embodiments of the present disclosure further include systems, methods and apparatuses of seamless integration of augmented, alternate, virtual, and/or mixed realities with physical realities for enhancement of web, mobile and/or other digital experiences. Embodiments of the present disclosure further include systems, methods and apparatuses to facilitate physical and non-physical interaction/action/reactions between alternate realities. Embodiments of the present disclosure also systems, methods and apparatuses of multidimensional mapping of universal locations or location ranges for alternate or augmented digital experiences. Yet further embodiments of the present disclosure include systems, methods and apparatuses to create real world value and demand for virtual spaces via an alternate reality environment.

The disclosed platform enables and facilitates authoring, discovering, and/or interacting with virtual objects (VOBs). One example embodiment includes a system and a platform that can facilitate human interaction or engagement with virtual objects (hereinafter, ‘VOB,’ or ‘VOBs’) in a digital realm (e.g., an augmented reality environment (AR), an alternate reality environment (AR), a mixed reality environment (MR) or a virtual reality environment (VR)). The human interactions or engagements with VOBs in or via the disclosed environment can be integrated with and bring utility to everyday lives through integration, enhancement or optimization of our digital activities such as web browsing, digital (online, or mobile shopping) shopping, socializing (e.g., social networking, sharing of digital content, maintaining photos, videos, other multimedia content), digital communications (e.g., messaging, emails, SMS, mobile communication channels, etc.), business activities (e.g., document management, document procession), business processes (e.g., IT, HR, security, etc.), transportation, travel, etc.

The disclosed innovation provides another dimension to digital activities through integration with the real world environment and real world contexts to enhance utility, usability, relevancy, and/or entertainment or vanity value through optimized contextual, social, spatial, temporal awareness and relevancy. In general, the virtual objects depicted via the disclosed system and platform. can be contextually (e.g., temporally, spatially, socially, user-specific, etc.) relevant and/or contextually aware. Specifically, the virtual objects can have attributes that are associated with or relevant real world places, real world events, humans, real world entities, real world things, real world objects, real world concepts and/or times of the physical world, and thus its deployment as an augmentation of a digital experience provides additional real life utility.

Note that in some instances, VOBs can be geographically, spatially and/or socially relevant and/or further possess real life utility. In accordance with embodiments of the present disclosure, VOBs can be or appear to be random in appearance or representation with little to no real world relation and have little to marginal utility in the real world. It is possible that the same VOB can appear random or of little use to one human user while being relevant in one or more ways to another user in the AR environment or platform.

The disclosed platform enables users to interact with VOBs and deployed environments using any device (e.g., devices 102A-N in the example of FIG. 1), including by way of example, computers, PDAs, phones, mobile phones, tablets, head mounted devices, goggles, smart watches, monocles, smart lens, smart watches and other smart apparel (e.g., smart shoes, smart clothing), and any other smart devices.

In one embodiment, the disclosed platform includes an information and content in a space similar to the World Wide Web for the physical world. The information and content can be represented in 3D and or have 360 or near 360 degree views. The information and content can be linked to one another by way of resource identifiers or locators. The host server (e.g., host server 100 as depicted in the example of FIG. 1) can provide a browser, a hosted server, and a search engine, for this new Web.

Embodiments of the disclosed platform enables content (e.g., VOBs, third party applications, AR-enabled applications, or other objects) to be created and placed into layers (e.g., components of the virtual world, namespaces, virtual world components, digital namespaces, etc.) that overlay geographic locations by anyone, and focused around a layer that has the highest number of audience (e.g., a public layer). The public layer can in some instances, be the main discovery mechanism and source for advertising venue for monetizing the disclosed platform.

In one embodiment, the disclosed platform includes a virtual world that exists in another dimension superimposed on the physical world. Users can perceive, observe, access, engage with or otherwise interact with this virtual world via a user interface (e.g., user interface 104A-N as depicted in the example of FIG. 1) of client application (e.g., accessed via using a user device, such as devices 102A-N as illustrated in the example of FIG. 1).

One embodiment of the present disclosure includes a consumer or client application component (e.g., as deployed on user devices, such as user devices 102A-N as depicted in the example of FIG. 1) which is able to provide geo-contextual awareness to human users of the AR environment and platform. The client application can sense, detect or recognize virtual objects and/or other human users, actors, non-player characters or any other human or computer participants that are within range of their physical location, and can enable the users to observe, view, act, interact, react with respect to the VOBs.

Furthermore, embodiments of the present disclosure further include an enterprise application (which can be desktop, mobile or browser based application). In this case, retailers, advertisers, merchants or third party e-commerce platforms/sites/providers can access the disclosed platform through the enterprise application which enables management of paid advertising campaigns deployed via the platform.

Users (e.g., users 116A-N of FIG. 1) can access the client application which connects to the host platform (e.g., as hosted by the host server 100 as depicted in the example of FIG. 1). The client application enables users (e.g., users 116A-N of FIG. 1) to sense and interact with virtual objects (“VOBs”) and other users (“Users”), actors, non-player characters, players, or other participants of the platform. The VOBs can be marked or tagged (by QR code, other bar codes, or image markers) for detection by the client application.

One example of an AR environment deployed by the host (e.g., the host server 100 as depicted in the example of FIG. 1) enables users to interact with virtual objects (VOBs) or applications related to shopping and retail in the physical world or online/e-commerce or mobile commerce. Retailers, merchants, commerce/e-commerce platforms, classified ad systems, and other advertisers will be able to pay to promote virtual objects representing coupons and gift cards in physical locations near or within their stores. Retailers can benefit because the disclosed platform provides a new way to get people into physical stores. For example, this can be a way to offer VOBs can are or function as coupons and gift cards that are available or valid at certain locations and times.

Additional environments that the platform can deploy, facilitate, or augment can include for example AR-enabled games, collaboration, public information, education, tourism, travel, dining, entertainment etc.

The seamless integration of real, augmented and virtual for physical places/locations in the universe is a differentiator. In addition to augmenting the world, the disclosed system also enables an open number of additional dimensions to be layered over it and, some of them exist in different spectra or astral planes. The digital dimensions can include virtual worlds that can appear different from the physical world. Note that any point in the physical world can index to layers of virtual worlds or virtual world components at that point. The platform can enable layers that allow non-physical interactions.

Embodiments of the present disclosure includes systems, methods and apparatuses of: edge oriented camera system (e.g., a periscope mode camera).

Embodiments of the present disclosure include, systems, methods and apparatuses of edge (e.g., top edge and/or bottom edge) oriented cameras and/or sensors on mobile devices or other portable devices. In this manner, a user can hold a device in hand, look down at it, and see what is in front of them, instead of having to hold the device up (e.g., vertically or near vertically) in front of them to do this (which is hard for arms and hard on neck and back on a regular or sustained basis). This can be applicable for augmented reality or virtual reality applications. The innovation can also apply to wearables like smartwatches, or other hand held mobile devices.

In one example embodiment, a camera bay can mechanically swivel as a phone or other portable device is moved to always provide a level image of what is in front of phone, regardless of phone orientation to the horizontal plane of the ground. This can also be implemented partially or fully in software by processing the image as the camera and/or camera bay move, as long as there is either an edge facing lens, or the camera bay is able to move to orient towards the edge by varying degrees as the camera moves.

FIG. 1 illustrates an example block diagram of a host server 100 able to facilitate adjustment of an orientation of an imaging unit of a mobile device or user device, in accordance with embodiments of the present disclosure.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102A-N can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device, a head mounted device, a smart watch, a goggle, a smart glasses, a smart contact lens, and/or any other portable, mobile, hand held devices, etc. The input mechanism on client devices 102A-N can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

The client devices 102A-N, application publisher/developer 108A-N, its respective networks of users, a third party content provider 112, and/or promotional content server 114, can be coupled to the network 106 and/or multiple networks. In some embodiments, the devices 102A-N and host server 100 may be directly connected to one another. The alternate, augmented provided or developed by the application publisher/developer 108A-N can include any digital, online, web-based and/or mobile based environments including enterprise applications, entertainment, games, social networking, e-commerce, search, browsing, discovery, messaging, chatting, and/or any other types of activities (e.g., network-enabled activities).

In one embodiment, the host server 100 is operable to facilitate adjustment of an orientation of an imaging unit of a mobile device or user device (e.g., one or more of user devices 102A-N).

In one embodiment, the disclosed framework includes systems and processes for enhancing the web and its features with augmented reality. Example components of the framework can include:
Browser (mobile browser, mobile app, web browser, etc.)
Servers and namespaces the host (e.g., host server 100 can host the servers and namespaces. The content (e.g, VOBs, any other digital object), applications running on, with, or integrated with the disclosed platform can be created by others (e.g., third party content provider 112, promotions content server 114 and/or application publisher/developers 108A-N, etc.).
Advertising system (e.g., the host server 100 can run an advertisement/promotions engine through the platform and any or all deployed augmented reality, alternate reality, mixed reality or virtual reality environments)
Commerce (e.g., the host server 100 can facilitate transactions in the network deployed via any or all deployed augmented reality, alternate reality, mixed reality or virtual reality environments and receive a cut. A digital token or digital currency (e.g., crypto currency) specific to the platform hosted by the host server 100 can also be provided or made available to users.)
Search and discovery (e.g., the host server 100 can facilitate search, discovery or search in the network deployed via any or all deployed augmented reality, alternate reality, mixed reality or virtual reality environments)
Identities and relationships (e.g., the host server 100 can facilitate social activities, track identifies, manage, monitor, track and record activities and relationships between users 116A).

Functions and techniques performed by the host server 100 and the components therein are described in detail with further references to the examples of FIG. 3A-3B.

In general, network 106, over which the client devices 102A-N, the host server 100, and/or various application publisher/provider 108A-N, content server/provider 112, and/or promotional content server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository 128, a virtual object repository 130, a virtual item repository 126, a chat stream repository 124, an AR storgy repository 122 and/or a VR background repository 132. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to generate, create and/or provide data to be stored in the user repository 128, the virtual object (VOB) repository 130, the virtual item 126, the chat stream repository 124, the AR story repository 122 and/or the VR background repository 132. The user repository 128 can store user information, user profile information, demographics information, analytics, statistics regarding human users, user interaction, brands advertisers, virtual object (or ‘VOBs’), access of VOBs, usage statistics of VOBs, ROI of VOBs, etc.

The virtual object repository 130 can store virtual objects and any or all copies of virtual objects. The VOB repository 130 can store virtual content or VOBs that can be retrieved for consumption in a target environment, where the virtual content or VOBs are contextually relevant. The VOB repository 130 can also include data which can be used to generate (e.g., generated in part or in whole by the host server 100 and/or locally at a client device 102A-N) contextually-relevant or aware virtual content or VOB(s).

The VR background repository 132 can store images, videos, photos or other media for use in a background to depict chat messages, chat bubbles and/or chat streams. The VR background repository 132 can store content or digital media and/or corresponding indicia that can be retrieved for depiction, reproduction or presentation or mixing into a AR environment. The VR background repository 132 can also include data which can be used to generate (e.g., generated in part or in whole by the host server 100 and/or locally at a client device 102A-N) or reproduce VR backgrounds.

The AR story repository 122 can store identifications of the number of layers or sublayers, identifiers for the BR layers or sublayers and/or rendering metadata of each given BR layer and/or sublayer for the host server 100 or client device 102A-N to render, create or generate or present the BR layer/sublayers. The chat stream repository 124 can store chat messages, chat streams, virtual items rendered and generated in a communication in the AR environment. The virtual item repository 126 can store various collections of virtual items which each includes multiple virtual objects added by any given user or users 116A-N.

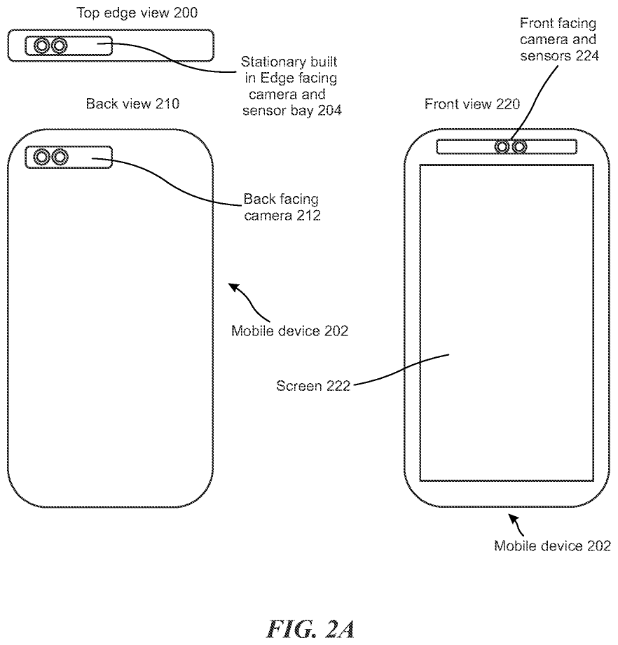

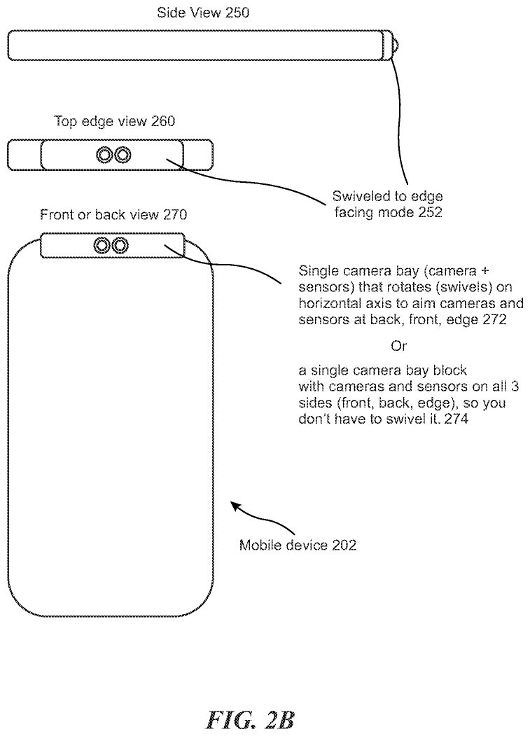

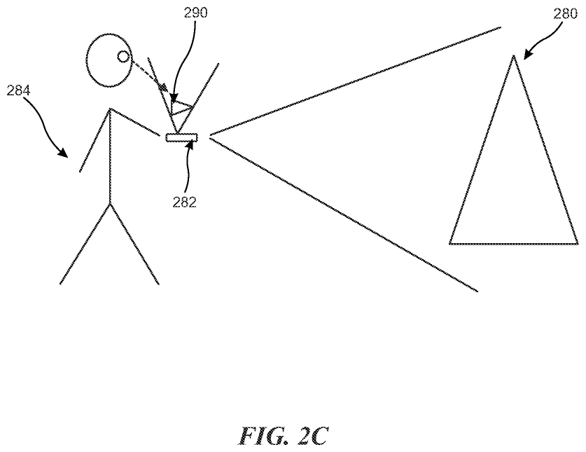

FIG. 2A depicts an example of a user interface of an edge view 200, a back view 210 and a front view 220 of a mobile device 202 with an edge-facing camera 204, in accordance with embodiments of the present disclosure.

In one embodiment, the edge-facing camera 204 can include an imaging unit which is built in or integrated with the mobile device 202. For example, the imaging unit having the edge facing camera 204 can therefore be stationary. The imaging unit can also include a sensor bay. The mobile device 202 (e., mobile phone) can therefore include a front facing camera 224.

FIG. 2B depicts an example of a user interface of an edge view 260, a side view 250 and a front view or back view 270 of a mobile device 202 with an edge-facing camera 252, in accordance with embodiments of the present disclosure.

One embodiment includes an apparatus having an imaging unit (e.g., the edge-facing camera 252). The imaging unit is optically coupled to the mobile device 202. The imaging unit (e.g. the edge-facing camera 252) can be mechanically attachable to the mobile device. The imaging unit can also be removable from the mobile device 202.

In one embodiment, the imaging unit 252 is operable to be rotated about an axis between a front side, a back side 270 and an edge side 260 of the mobile device 202, as shown in 272. The imaging unit can also be physically rotated about an axis between a front side, a back side and an edge side of the mobile device by a user of the mobile device 202. In one embodiment, the imaging unit can be rotated to the back side of the mobile device 202 and used as a back facing camera of the mobile device 202. The imaging unit 252 can also be rotated to the front side of the mobile device 252 and used as a front facing camera of the mobile device. The imaging unit 252 can also be rotated to the edge side of the mobile device and used as an edge facing camera of the mobile device.

For example the imaging unit 252 can be an attachment over an existing front facing lens on the mobile phone 252 such as a periscope lens prism that fits over the existing lens that is integrated with the mobile phone 202. The imaging unit 252 can be rotated off. The imaging unit 252 can also be attached to or clipped onto a phone case or the mobile phone 202 itself, and clipped off when not needed. Rotate it over the lens or off with your finger. Therefore, the periscope lens can be placed in front of normal front facing lens and then removed as needed.

In a further embodiment, the imaging unit 252 can have at least two camera bays. For example, one of the at least two camera bays can be operable to image an edge side 260 of the mobile device 202. The edge side of the mobile device is generally disposed between a front side of the mobile device 202 and a backside of the mobile device 202 and can include the top edge or the bottom edge of the mobile device. For example, the imaging unit 252 can have three camera bays on each of the front, back and edge sides. In this manner, the imaging unit 252 does not need to be rotated or swiveled to image the edge facing side 260, as shown in 274.

FIG. 2C depicts an example diagram showing an edge-facing camera enabled mobile device 282 in operation, in accordance with embodiments of the present disclosure.

The edge facing camera enabled mobile device 282 can enable a user 284 to hold the mobile device 282 in hand, look down at it, and see and imaging target 280 that is in front of them on the mobile device screen 290. Therefore, the user 284 does not need to tilt the mobile device up in front of them to achieve this and can maintain relatively the same orientation/tilt it was in.

FIG. 3A depicts an example functional block diagram of a host server 300 that facilitates adjustment of an orientation of an imaging unit of a mobile device or user device, in accordance with embodiments of the present disclosure.

The host server 300 includes a network interface 302, an imaging unit adjustor 310, an imaging target positioning engine 340, a device orientation manager 350 and/or an AR application manager 360. The host server 300 is also coupled to an AR story repository 322, a chat stream repository 324 and/or a virtual item repository 326. Each of the imaging unit adjustor 310, the imaging target positioning engine 340, the device orientation manager 350 and/or the AR application manager 360. can be coupled to each other.

Additional or less modules can be included without deviating from the techniques discussed in this disclosure. In addition, each module in the example of FIG. 3A can include any number and combination of sub-modules, and systems, implemented with any combination of hardware and/or software modules.

The host server 300, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The network interface 302 can be a networking module that enables the host server 300 to mediate data in a network with an entity that is external to the host server 300, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.,), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

One embodiment of the host server 300 includes the imaging unit adjustor 310. The imaging unit adjustor 310 can be any combination of software agents and/or hardware modules (e.g., including processors and/or memory units) able to adjust, rotate, turn, swivel an imaging unit of a mobile device.

The adjustment can be achieved through an application running locally on the mobile device. In some instances, the imaging unit can include a wide angle lens coupled to the mobile device. In some instances, the mobile device includes an imaging unit that is edge-facing or near edge facing. The imaging unit adjustor 310 can then activate the imaging unit that is edge-facing when appropriate or required or optimal. In general, the imaging unit adjustor 310 is able to move the imaging unit of the mobile device to orient towards an edge (e.g., top edge or bottom edge) by varying degrees or configurable number of degrees as the mobile device moves.

One embodiment of the host server 300 further includes the imaging target positioning engine 340. The imaging target positioning engine 340 can be any combination of software agents and/or hardware modules (e.g., including processors and/or memory units) able to determine, compute, measure, ascertain, a position or location where an imaging target is located in a real world environment or where the imaging target is to be rendered or projected in the real world environment.

The imaging target position or location can be specified in qualitative or quantitative terms. The position or location can also be specified in absolute or relative terms. For example, The imaging target can be specified to be a certain distance from the mobile phone, an item in the room or physical space, from a person in the room or physical space, a distance from a wall or ceiling, or floor, or a building or other infrastructure. The distance can be specified as a lateral distance, a horizontal distance, a vertical distance, or any combination thereof. The location can also be specified as an angle (e.g., azimuth or altitude angle) in a reference frame.

One embodiment of the host server 300 includes the device orientation manager 350. The device orientation manager 310 can be any combination of software agents and/or hardware modules (e.g., including processors and/or memory units) able to determine, compute, measure, specify the orientation of a mobile device to capture or image and imaging target.

The device orientation manager 350, for example, is able to determine an incline plane of the mobile phone. The incline plane can be determined or specified in relation to a horizontal plane (e.g., the horizontal plane parallel or substantially parallel to the earth, ground, or other surface). The incline plane can also be determined or specified in relation to a vertical plane (e.g., a plane vertical to or substantially vertical to (e.g., at near 90 degrees to) the earth, ground or other surface. The incline plane of the mobile phone can be determined along a height (longer dimension) of the mobile phone.

The device orientation manager 350 can also determine a tilt angle of the mobile phone, where the tilt angle is determined along a width direction (shorter dimension) of the mobile phone. Similarly, the tilt angle relative to a horizontal plane and/or a vertical plane can be determined, computed and/or measured. The determined or specified location/position of the imaging target can be used by the imaging unit adjustor 310 to activate or to adjust the orientation of the edge facing camera of the mobile device. The device orientation measurements and the imaging target position or location can be used (e.g., by the imaging unit adjustor 310) to activate or adjust the positioning or orientation of the edge-facing camera.

FIG. 3B depicts an example block diagram illustrating the components of the host server 300 that facilitates adjustment of an orientation of an imaging unit of a mobile device or user device, in accordance with embodiments of the present disclosure.

In one embodiment, host server 300 includes a network interface 302, a processing unit 334, a memory unit 336, a storage unit 338, a location sensor 340, and/or a timing module 342. Additional or less units or modules may be included. The host server 300 can be any combination of hardware components and/or software agents to facilitate adjustment of an orientation of an imaging unit of a mobile device or user device. The network interface 302 has been described in the example of FIG. 3A.

One embodiment of the host server 300 includes a processing unit 334. The data received from the network interface 302, location sensor 340, and/or the timing module 342 can be input to a processing unit 334. The location sensor 340 can include GPS receivers, RF transceiver, an optical rangefinder, etc. The timing module 342 can include an internal clock, a connection to a time server (via NTP), an atomic clock, a GPS master clock, etc.

The processing unit 334 can include one or more processors, CPUs, microcontrollers, FPGAs, ASICs, DSPs, or any combination of the above. Data that is input to the host server 300 can be processed by the processing unit 334 and output to a display and/or output via a wired or wireless connection to an external device, such as a mobile phone, a portable device, a host or server computer by way of a communications component.

One embodiment of the host server 300 includes a memory unit 336 and a storage unit 338. The memory unit 335 and a storage unit 338 are, in some embodiments, coupled to the processing unit 334. The memory unit can include volatile and/or non-volatile memory. In virtual object deployment, the processing unit 334 may perform one or more processes related to facilitating adjustment of an orientation of an imaging unit of a mobile device or user device.

In some embodiments, any portion of or all of the functions described of the various example modules in the host server 300 of the example of FIG. 3A can be performed by the processing unit 334.

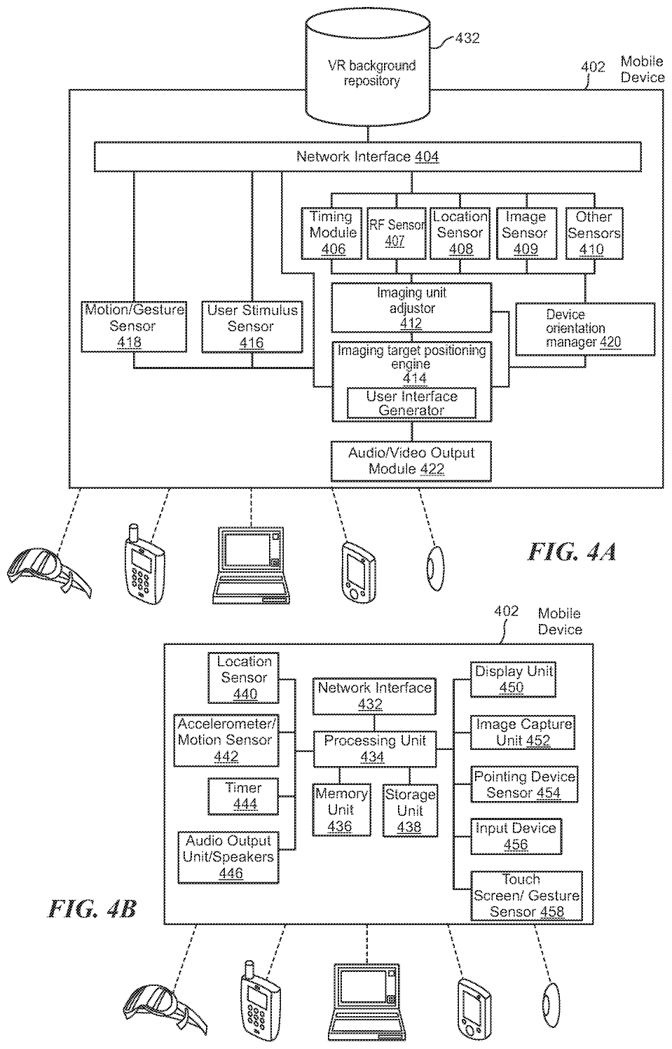

FIG. 4A depicts an example functional block diagram of a client device such as a mobile device 402 having an imaging unit with edge-facing capabilities, in accordance with embodiments of the present disclosure.

The client device 402 includes a network interface 404, a timing module 406, an RF sensor 407, a location sensor 408, an image sensor 409, an imaging unit adjustor 412, an imaging target positioning engine 414, a user stimulus sensor 416, a motion/gesture sensor 418, a device orientation manager 420, an audio/video output module 422, and/or other sensors 410. The client device 402 may be any electronic device such as the devices described in conjunction with the client devices 102A-N in the example of FIG. 1 including but not limited to portable devices, a computer, a server, location-aware devices, mobile phones, PDAs, laptops, palmtops, iPhones, cover headsets, heads-up displays, helmet mounted display, head-mounted display, scanned-beam display, smart lens, monocles, smart glasses/goggles, wearable computer such as mobile enabled watches or eyewear, and/or any other mobile interfaces and viewing devices, etc.

In one embodiment, the client device 402 is coupled to a VR background repository 432. The VR background repository 432 may be internal to or coupled to the mobile device 402 but the contents stored therein can be further described with reference to the example of the reality object repository 132 described in the example of FIG. 1.

Additional or less modules can be included without deviating from the novel art of this disclosure. In addition, each module in the example of FIG. 4A can include any number and combination of sub-modules, and systems, implemented with any combination of hardware and/or software modules.

The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 4A, the network interface 404 can be a networking device that enables the client device 402 to mediate data in a network with an entity that is external to the host server, through any known and/or convenient communications protocol supported by the host and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

According to the embodiments disclosed herein, the client device 402 can include an imaging unit with edge-facing capabilities to for example, detect a real world scene that is in front of a user of the mobile device (e.g., in a field of view of the user). The client device 402 can provide functionalities described herein via a consumer client application (app) (e.g., consumer app, client app. Etc.). The consumer application includes a user interface that enables adjustment of an imaging unit of the mobile device.

For example, the mobile device or user device 402 can include, a front panel having a display screen, a back panel on an opposite side of the front panel having the display screen, an edge panel disposed between the front panel and the back panel and/or an imaging sensor (e.g., the imaging sensor 409) operable to detect the real world scene via the edge panel. In one embodiment, the imaging sensor faces a direction of the edge panel. The imaging sensor can also be adjustable to face a direction of the edge panel.

One embodiment of the mobile device includes a processor (processing unit as shown in the example of FIG. 4B) coupled to the imaging sensor and memory coupled to the processor. The memory can have stored thereon instructions, which when executed by the processor, cause the processor to orient the imaging sensor towards the edge panel.

The memory can have further stored thereon instructions, which when executed by the processor, cause the processor to: identify an incline plane of the mobile device relative to a horizontal plane and/or adjust a direction of the imaging sensor based on the incline plane of the mobile phone relative to the horizontal plane. For example, the horizontal plane can be substantially parallel to or parallel to the ground (e.g., floor, earth, ceiling, any flat surface or flat plane, table, chair, etc.). In a further embodiment, the mobile device 402 can include an imaging sensor that is externally coupled to the mobile device 402 and remove-able from the mobile device, in addition to or in lieu of the imaging sensor internal to the mobile device 402.

FIG. 4B depicts an example block diagram of the client device, which can be a mobile device 402 having an imaging unit with edge-facing capabilities, in accordance with embodiments of the present disclosure.

In one embodiment, client device 402 (e.g., a user device) includes a network interface 432, a processing unit 434, a memory unit 436, a storage unit 438, a location sensor 440, an accelerometer/motion sensor 442, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for facilitating adjustment of an imaging unit of the mobile device. The network interface 432 has been described in the example of FIG. 4A.

One embodiment of the client device 402 further includes a processing unit 434. The location sensor 440, accelerometer/motion sensor 442, and timer 444 have been described with reference to the example of FIG. 4A.

The processing unit 434 can include one or more processors, CPUs, microcontrollers, FPGAs, ASICs, DSPs, or any combination of the above. Data that is input to the client device 402 for example, via the image capture unit 452, pointing device/sensor 454, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer that generates and controls access to simulated objects by way of a communications component.

One embodiment of the client device 402 further includes a memory unit 436 and a storage unit 438. The memory unit 436 and a storage unit 438 are, in some embodiments, coupled to the processing unit 434. The memory unit can include volatile and/or non-volatile memory. In rendering or presenting an augmented reality environment, the processing unit 434 can perform one or more processes related to facilitating or depicting transitioning in virtualness level for a scene.

In some embodiments, any portion of or all of the functions described of the various example modules in the client device 402 of the example of FIG. 4A can be performed by the processing unit 434. In particular, with reference to the mobile device illustrated in FIG. 4A, various sensors and/or modules can be performed via any of the combinations of modules in the control subsystem that are not illustrated, including, but not limited to, the processing unit 434 and/or the memory unit 436.

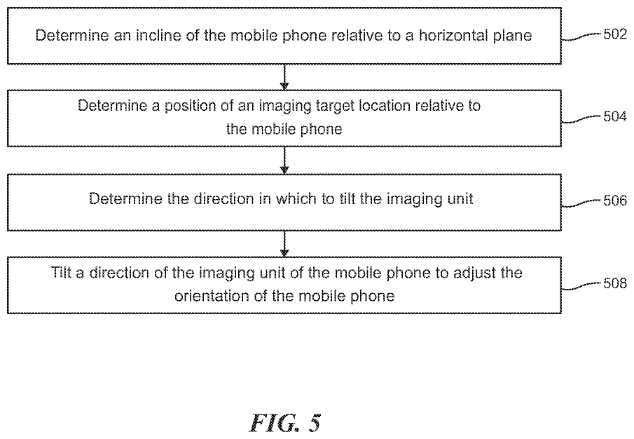

FIG. 5 depicts a flow chart illustrating an example process to adjust an orientation of an imaging unit of a mobile phone, in accordance with embodiments of the present disclosure.

In process 502, an incline of the mobile phone relative to a horizontal plane is determined. In one embodiment, the horizontal plane is substantially parallel to parallel to, or near parallel to the ground (e.g., physical ground, floor, earth, etc.). For instance, the horizontal plane can be substantially parallel to the ground where the user of the mobile phone is generally vertical to the ground (as shown in the example of FIG. 2C).

In process 504, a position of an imaging target location relative to the mobile phone is determined. The imaging target can include physical objects, things, and/or persons in a real world location where the mobile phone and user of the phone are located. The imaging target can also include a digital object that is rendered (e.g., by the mobile phone or other devices) to appear in a physical location in the real world location. The position of the imaging target location can be determined. The position can include the height of the imaging target location from the ground, the distance from any number of walls or other physical objects in the real world location, or the distance from the mobile device.

The position can also include an angle of the imaging target from the vertical plane of the ground and/or from the horizontal plane parallel to the ground (e.g., earth, floor, etc.). The position can also be identified or measured by an azimuth angle and/or an elevation angle. In some instances, the position can be measured or determined based on a line of sight or field of vision of a user of the mobile phone.

In process 506, the direction in which to tilt the imaging unit is determined. In one embodiment, the direction in which to tilt the imaging unit can be based on the incline of the mobile phone and/or the position of the imaging target location. The imaging unit can be tilted, swiveled, rotated, or otherwise adjusted to tilt towards a front side of the mobile phone (or other mobile device), a backside of the mobile phone, or an edge side of the mobile phone. In some instance, the imaging unit can also be tilted based on user configuration, system setting, device setting, operating system configuration, and/or application settings.

In process 508, the direction of the imaging unit of the mobile phone is tilted to adjust the orientation of the mobile phone. The direction of the imaging unit of the mobile phone can be tilted towards a front side, a back side or an edge side of the mobile phone. The front, back and side edges are illustrated in the example of FIG. 2A-FIG. 2B. The imaging unit can be internal to the mobile phone. For example, the imaging unit can include a wide angle lens and can be controlled by software in the mobile phone (e.g., operating system, device firm ware and/or third party applications).

In other embodiments, the imaging unit can be or include an external attachment to the mobile phone. For example, the imaging unit can be mechanically coupled to the mobile phone and where the direction of the imaging unit is swiveled mechanically along a horizontal axis such that the orientation of the imaging unit is tilted towards the front side, the back side, or the edge side of the mobile phone. In addition, the imaging unit can be swiveled or rotated mechanically by a user of the mobile phone.

In some instance, there can be multiple imaging units internal and/or external to a mobile phone. For example, the mobile phone may have multiple imaging units internal to it, at least some of which are edge-facing or adjustable to become edge facing. The mobile phone may have multiple external imaging units, at least some of which are edge facing or adjustable to become edge-facing. Similarly the mobile phone may have a combination of imaging units that are internal and external to it, and at least some of which are edge facing or adjustable to become edge-facing.

FIG. 6 is a block diagram illustrating an example of a software architecture 600 that may be installed on a machine, in accordance with embodiments of the present disclosure.

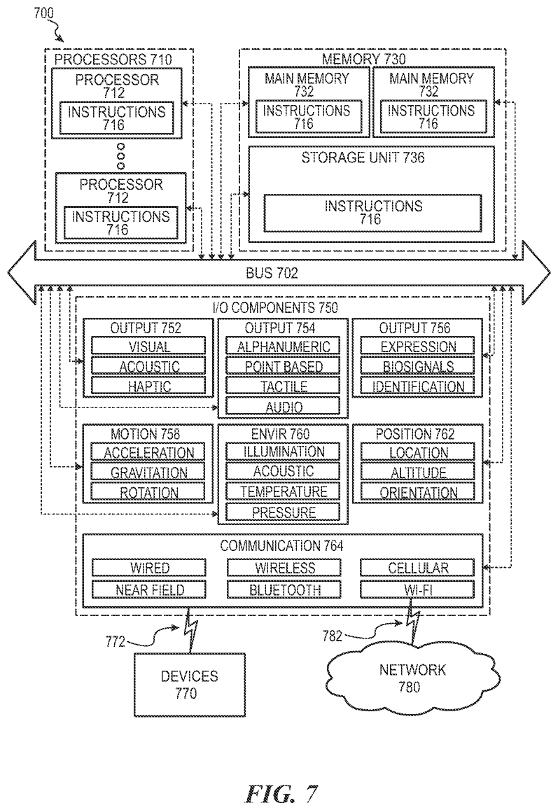

FIG. 6 is a block diagram 600 illustrating an architecture of software 602, which can be installed on any one or more of the devices described above. FIG. 6 is a non-limiting example of a software architecture, and it will be appreciated that many other architectures can be implemented to facilitate the functionality described herein. In various embodiments, the software 602 is implemented by hardware such as machine 700 of FIG. 7 that includes processors 710, memory 730, and input/output (I/O) components 750. In this example architecture, the software 602 can be conceptualized as a stack of layers where each layer may provide a particular functionality. For example, the software 602 includes layers such as an operating system 604, libraries 606, frameworks 608, and applications 610. Operationally, the applications 610 invoke API calls 612 through the software stack and receive messages 614 in response to the API calls 612, in accordance with some embodiments.

In some embodiments, the operating system 604 manages hardware resources and provides common services. The operating system 604 includes, for example, a kernel 620, services 622, and drivers 624. The kernel 620 acts as an abstraction layer between the hardware and the other software layers consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH drivers, flash memory drivers, serial communication drivers (e.g., Universal Serial Bus (USB) drivers), WI-FI drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematics functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphic user interface (GUI) functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a search/discovery application 656, a location application 658, a media application 660, a messaging application 662, a game application 664, and other applications such as a third party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third party application 666 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 666 can invoke the API calls 612 provided by the operating system 604 to facilitate functionality described herein.

An augmented reality application 667 may implement any system or method described herein, including integration of augmented, alternate, virtual and/or mixed realities for digital experience enhancement, or any other operation described herein.

FIG. 7 is a block diagram illustrating components of a machine 700, according to some example embodiments, able to read a set of instructions from a machine-readable medium (e.g., a machine-readable storage medium) and perform any one or more of the methodologies discussed herein.

Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described.

In alternative embodiments, the machine 700 operates as a standalone device or can be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 can include processors 710, memory/storage 730, and I/O components 750, which can be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 712 and processor 714 that may execute instructions 716. The term “processor” is intended to include multi-core processor that may comprise two or more independent processors (sometimes referred to as “cores”) that can execute instructions contemporaneously. Although FIG. 7 shows multiple processors, the machine 700 may include a single processor with a single core, a single processor with multiple cores (e.g., a multi-core processor), multiple processors with a single core, multiple processors with multiples cores, or any combination thereof.

The memory/storage 730 can include a main memory 732, a static memory 734, or other memory storage, and a storage unit 736, both accessible to the processors 710 such as via the bus 702. The storage unit 736 and memory 732 store the instructions 716 embodying any one or more of the methodologies or functions described herein. The instructions 716 can also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 716. The term “machine-readable medium” or “machine-readable storage medium” shall also be taken to include any medium, or combination of multiple media, that is capable of storing, encoding or carrying a set of instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 750 can include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 can include many other components that are not shown in FIG. 7. The I/O components 750 are grouped according to functionality merely for simplifying the following discussion and the grouping is in no way limiting. In example embodiments, the I/O components 750 can include output components 752 and input components 754. The output components 752 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 752 can include biometric components 756, motion components 758, environmental components 760, or position components 762 among a wide array of other components. For example, the biometric components 756 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 can include acceleration sensor components (e.g., an accelerometer), gravitation sensor components, rotation sensor components (e.g., a gyroscope), and so forth. The environmental components 760 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 762 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 750 may include communication components 764 operable to couple the machine 700 to a network 780 or devices 770 via a coupling 782 and a coupling 772, respectively. For example, the communication components 764 include a network interface component or other suitable device to interface with the network 780. In further examples, communication components 764 include wired communication components, wireless communication components, cellular communication components, Near Field Communication (NFC) components, Bluetooth. components (e.g., Bluetooth. Low Energy), WI-FI components, and other communication components to provide communication via other modalities. The devices 770 may be another machine or any of a wide variety of peripheral devices (e.g., a peripheral device coupled via a USB).

The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 764 can detect identifiers or include components operable to detect identifiers. For example, the communication components 764 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 764, such as location via Internet Protocol (IP) geo-location, location via WI-FI signal triangulation, location via detecting a BLUETOOTH or NFC beacon signal that may indicate a particular location, and so forth.

In various example embodiments, one or more portions of the network 780 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or other type of cellular or wireless coupling. In this example, the coupling 782 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 can be transmitted or received over the network 780 using a transmission medium via a network interface device (e.g., a network interface component included in the communication components 764) and utilizing any one of a number of transfer protocols (e.g., HTTP). Similarly, the instructions 716 can be transmitted or received using a transmission medium via the coupling 772 (e.g., a peer-to-peer coupling) to devices 770. The term “transmission medium” shall be taken to include any intangible medium that is capable of storing, encoding, or carrying the instructions 716 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”.) Accordingly, the applicant reserves the right to add additional claims after filing the application to pursue such additional claim forms for other aspects of the disclosure.

What is claimed is:

1. A method to adjust an orientation of an imaging unit of a mobile phone, the method, comprising:
tilting a direction of the imaging unit of the mobile phone to adjust the orientation;
wherein, the direction of the imaging unit of the mobile phone is tilted in towards a front side, a back side or an edge side of the mobile phone.

2. The method of claim 1, further comprising:
determining an incline of the mobile phone relative to a horizontal plane;
wherein, the horizontal plane is substantially parallel to the ground;
determining the direction in which to tilt the imaging unit based on the incline of the mobile phone.

3. The method of claim 1, further comprising:
determining an incline of the mobile phone relative to a horizontal plane;
determining a position of an imaging target location relative to the mobile phone;
determining the direction in which to tilt the imaging unit based on the incline of the mobile phone and the position of the imaging target location.

4. The method of claim 1, wherein:
the imaging unit is tilted based on user configuration or setting.

5. The method of claim 1, wherein:
the imaging unit includes a wide angle lens.

6. The method of claim 1, wherein:
the imaging unit is internal to the mobile phone.

7. The method of claim 1, wherein:
the imaging unit is an external attachment to the mobile phone;
wherein, the imaging unit is mechanically coupled to the mobile phone;
wherein, the direction of the imaging unit is swiveled mechanically along a horizontal axis such that the orientation of the imaging unit is tilted towards the front side, the back side, or the edge side of the mobile phone.

8. The method of claim 1, wherein:
the imaging unit is swiveled mechanically by a user of the mobile phone.

9. An apparatus, comprising:
an imaging unit adapted to be optically coupled to a mobile device;
wherein, the imaging unit includes at least one camera bay;
wherein, the imaging unit is mechanically attachable to the mobile device.

10. The apparatus of claim 9, wherein:
the imaging unit is removable from the mobile device.

11. The apparatus of claim 9, wherein:
in operation, the imaging unit is operable to be rotated about an axis between a front side, a back side and an edge side of the mobile device.

12. The apparatus of claim 11, wherein:
in operation, the imaging unit is operable to be physically rotated about an axis between a front side, a back side and an edge side of the mobile device by a user of the mobile device.

13. The apparatus of claim 11, wherein:
in operation, the imaging unit is operable to be rotated to the front side of the mobile device and used as a front facing camera of the mobile device.

14. The apparatus of claim 11, wherein:
in operation, the imaging unit is operable to be rotated to the back side of the mobile device and used as a back facing camera of the mobile device.

15. The apparatus of claim 11, wherein:
in operation, the imaging unit is operable to be rotated to the edge side of the mobile device and used as an edge facing camera of the mobile device.

16. The apparatus of claim 9, wherein:
the imaging unit includes at least two camera bays, wherein, one of the at least two camera bays is operable to image an edge side of the mobile device;
wherein, the edge side of the mobile device is disposed between a front side of the mobile device and a backside of the mobile device.

17. A mobile device to detect a real world scene in front of a user of the mobile device, the mobile device, comprising:
a front panel having a display screen;
a back panel on an opposite side of the front panel having the display screen;
an edge panel disposed between the front panel and the back panel;
an imaging sensor operable to detect the real world scene via the edge panel.

18. The mobile device of claim 17, wherein:
the imaging sensor faces a direction of the edge panel.

19. The mobile device of claim 17, wherein:
the imaging sensor adjustable to face a direction of the edge panel;
the imaging sensor is externally coupled to the mobile device and removeable from the mobile device.

20. The mobile device of claim 17, further comprising:
a processor coupled to the imaging sensor, the imaging sensor being internal to the mobile device;
memory coupled to the processor, the memory having stored thereon instructions, which when executed by the processor, cause the processor to:
identify an incline plane of the mobile device relative to a horizontal plane;
wherein, the horizontal plane is substantially parallel to the ground;
adjust a direction of the imaging sensor based on the incline plane of the mobile phone relative to the horizontal plane;
orient the imaging sensor towards the edge panel;
depict and render an augmented reality application via the display screen.
